(19) United States
(12) Patent Application Publication
(10) Pub. No.: US 2012/0064499 A1
(43) Pub. Date: Mar. 15, 2012

(54) TEACHING LESSONS WITHIN AN ELECTRONIC DEVICE

(75) Inventors: Stephan Samuelson, San Antonio, TX (US); Henry Halff, San Antonio, TX (US); Lawrence Halff, San Francisco, CA (US); Todd Miller, Piscataway, NJ (US)

(73) Assignee: Twist Education, LLC, San Antonio, TX (US)

(21) Appl. No.: 13/321,811

(22) PCT Filed: Oct. 18, 2010
(86) PCT No.: PCT/US10/53080

§ 371 Date: Nov. 21, 2011

Related U.S. Application Data
(60) Provisional application No. 61/253,055, filed on Oct. 19, 2009.
(60) Provisional application No. 61/253,370, filed on Oct. 20, 2009.

(51) Int. Cl. G09B 5/00

(52) U.S. Cl. 434/309

(57) ABSTRACT

Electronic devices with user interfaces, including but not limited to systems and methods for modifying screen content within a graphical user interface based upon user inputs are provided. Methods for providing visual lessons on an electronic device are provided. Such methods can involve one or more levels, with each level comprising one or more teaching concepts, and a number of levels corresponding to a course. These concepts can correspond to subtopics within an overall course subject. A user of an electronic device can be required to learn and master one or more concepts in a particular order, or in other instances the individual concepts within a level can be navigated in alternative sequences as specified by configurable program code of the technology. Lessons can be linked within an over-all story.

### CROSS-REFERENCE TO RELATED APPLICATIONS

This application claims priority benefit of U.S. provisional application No. 61/253,055, filed Oct. 19, 2009. U.S provisional application No. 61/253,055, is fully incorporated by reference herein. This application claims priority benefit of U.S. provisional application No. 61/253,370, filed Oct. 20, 2009. U.S provisional application No. 61/253,370, is fully incorporated by reference herein.

### FIELD OF TECHNOLOGY

The present application relates generally to electronic devices with user interfaces, including but not limited to systems and methods for modifying screen content within a graphical user interface based upon user inputs.

### BRIEF DESCRIPTION OF THE DRAWINGS

Implementations of the present disclosure will now be described, by way of example only, with reference to the attached Figures, wherein:

FIG. 1 is a display of an electronic device presenting a visual lesson in accordance within an exemplary implementation;

FIG. 2 illustrates various levels within an exemplary implementation;

FIG. 3 illustrates various levels in a form of a role-playing game within an exemplary implementation;

FIG. 4 illustrates various levels corresponding to one or more texts within an exemplary implementation;

FIG. 5 is a display of an electronic device in accordance within an exemplary implementation;

FIG. 6 is a screen shot in accordance within an exemplary implementation;

FIG. 7 is display of an electronic device in accordance within an exemplary implementation;

FIG. 8 is a screen shot of a display of an electronic device in accordance within an exemplary implementation;

FIG. 9 is a screen shot of a display of an electronic device in accordance within an exemplary implementation;

FIG. 10 is a screen shot of a display of an electronic device in accordance within an exemplary implementation;

FIG. 11a is display of an electronic device in accordance within an exemplary implementation;

FIG. 11b is a screen shot of a display of an electronic device in accordance within an exemplary implementation;

FIG. 11c is display of an electronic device in accordance within an exemplary implementation;

FIG. 12 is a screen shot of a display of an electronic device in accordance within an exemplary implementation;

FIG. 13 is display of an electronic device in accordance within an exemplary implementation;

FIG. 14 is a flowchart of a method in accordance with an exemplary implementation;

FIG. 15 is a screenshot of a display of an electronic device in accordance within an exemplary implementation;

FIG. 16 screenshot of a display of an electronic device depicting a non-player character in accordance within an exemplary implementation;

FIG. 17 is a screenshot of a display of an electronic device in accordance within an exemplary implementation;

FIG. 18 is a screenshot of a display of an electronic device in accordance within an exemplary implementation;

FIG. 19 is a screenshot of a display of an electronic device in accordance within an exemplary implementation;

FIG. 20 is a screenshot of a device-user log in menu in accordance within an exemplary implementation;

FIG. 21 is a screenshot of a device-user character selection menu in accordance within an exemplary implementation;

FIG. 22 is a screenshot of an example inventory system in accordance within an exemplary implementation;

FIG. 23 is a screenshot of a display of an electronic device in accordance within an exemplary implementation; and

FIG. 24 is a screenshot of an example teaching game in accordance within an exemplary implementation.

### DETAILED DESCRIPTION

Reference will now be made in detail to embodiments in accord with the present technology, examples of which are illustrated in the accompanying figures. For simplicity and clarity of illustration, reference numerals may be repeated among the figures to indicate corresponding or analogous elements. In addition, numerous specific details are set forth in order to provide a thorough understanding of the example embodiments described herein. The example embodiments described herein may be practiced without these specific details. In other instances, methods, procedures and components have not been described in detail so as not to obscure the embodiments described herein. Also, this description is not to be considered as limiting the scope of the embodiments described herein.

Some portions of the detailed description which follow are presented in terms of procedures, flowcharts, processing and other various operations on data in computer memory or other storage media. Examplary embodiments within this disclosure may be discussed in the context of computer-executable instructions which reside on one or more computer-readable media, such as program modules or applets. Programming modules can include but are not limited to routines, sub-routines, programs, functions, function-calls, objects, classes and data structures, etc. The operational functions of the programming modules may be combined or parsed in various embodiments.

An examplary embodiment of the present technology is an adventure game for teaching a subject, such as physics, chemistry, mechanics or the like. Although the methods and procedures within this disclosure are highly suitable for teaching subject matter having a mathematical component, the methods and apparatuses described herein can be adapted for students learning subjects of other types, such as language, “French” or “Italian” for example, or history, such as “American History” or “World History.”

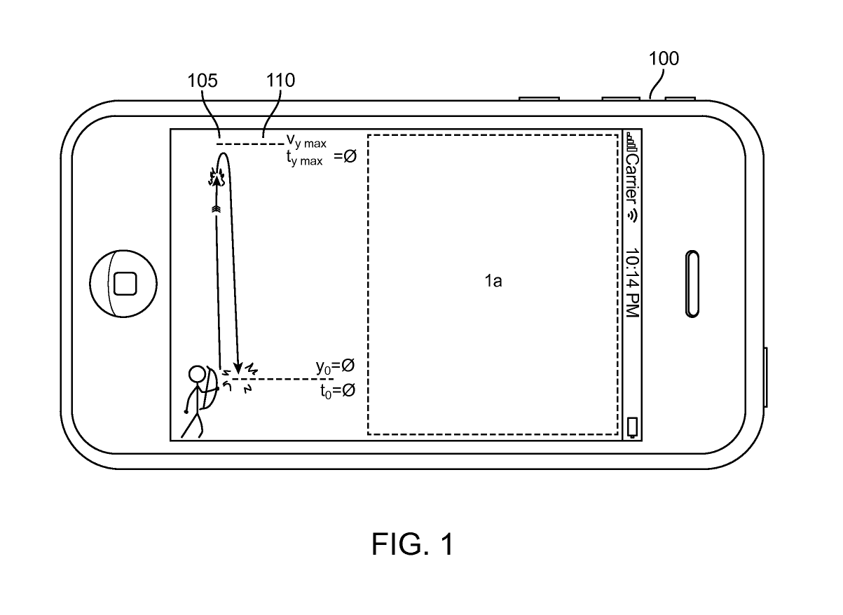

An example electronic device 100 is shown in FIG. 1. The embodiments are depicted in the figures by way of example only, and those persons skilled in the art understand the additional elements and modifications necessary to make the electronic device 100 work in particular network environments. Although the electronic device 100 in FIG. 1 illustrates a handheld communication device, the electronic device 100 may comprise a handheld wireless communication device, a personal digital assistant (PDA), laptop computer, desktop computer, a server, or other electronic device. The electronic device 100 displays a visual lesson 110 on a graphical user interface 105. The screenshot of the visual lesson 110 on FIG. 1 contains the following text at 1a:

The technology within this disclosure can take the form of an entirely hardware embodiment, an entirely software embodiment or an embodiment containing both hardware and software elements. In one embodiment, the technology is implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD). Both processors and program code for implementing the methods and procedures described in this disclosure, each as an aspect of the technology, can be centralized or distributed (or a combination thereof) as known by those skilled in the art.

A data processing system suitable for storing and executing program code will include at least one processor coupled directly or indirectly to memory elements through a system bus. Further, program code and processing elements can be combined, e.g., as in a field programmable gate array (FPGA) or an application-specific integrated circuit (ASIC). The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, touch screens, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

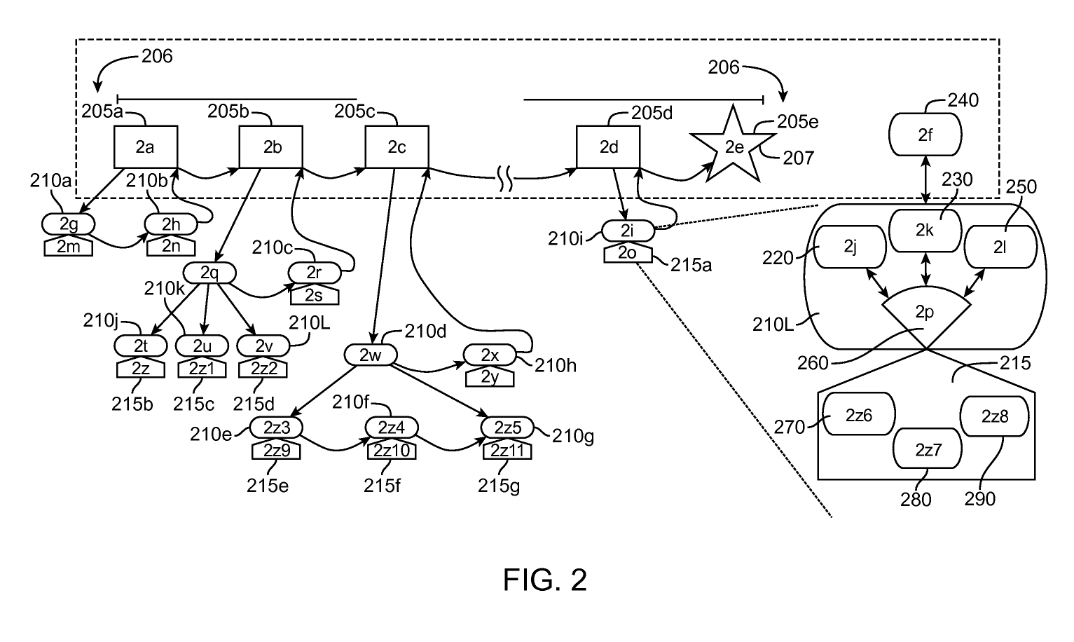

Methods for providing visual lessons 110 on an electronic device 100 are provided. As depicted in FIG. 2 such methods can involve one or more levels 205, with each level 205 comprising one or more teaching concepts 210, and a number of levels 205 corresponding to a course 206. These concepts 210 correspond to subtopics within an overall course 206 subject. The method provides that a user can be required to learn and master one or more concepts 210 in a particular order, or in other instances the individual concepts 210 within a level can be navigated in alternative sequences as specified by configurable program code of the technology. As described above, technology disclosed herein can be applied to virtually any course 206 or curriculum. Within this disclosure, a complete course 206 (for example, ‘chemistry’ or ‘biology’) can be taught through completion of all levels 205. Some students may possess prior knowledge of some concepts 210 within the levels 205. For that reason some embodiments of the present technology allow a student the option to bypass certain levels 205 or individual concepts 210 within the levels 205. However, embodiments of the present technology generally provide that levels 205 will be completed in sequence as established by configurable program code for an individual course 206. Likewise, the present technology can require that concepts 210 within a level must be mastered by a student before a student is permitted to move to a subsequent level. Additionally, each of the concepts 210 described above can reside within a stand-alone or micro-application or applet to be run within one or more computer program products.

Referring to FIG. 2, the following identification numbers correspond to the following text as follows:

2a: Level 1;

2b: Level 2;

2c: Level 3;

2d: Level n;

2e: Level n+1;

2f: Course Update Function;

2g: Concept 1;

2h: Concept 3;

2i: Concept n;

2j: Cognitive Analysis Algorithm;

2k: Update Function;

2l: Problem Generation Algorithm;

2m: Student Interface;

2n: Student Interface;

2o: Student Interface;

2p: Student Model;

2q: Concept 3;

2r: Concept 4;

2s: Student Interface;

2t: Concept 3.1;

2u: Concept 3.2;

2v: Concept 3.3;

2w: Concept 5;

2x: Concept 6;

2y: Student Interface;

2z: Student Interface;

2z1: Student Interface;

2z2: Student Interface;

2z3: Concept 5.1;

2z4: Concept 5.1.2;

2z5: Concept 5.2;

2z6: Instructional Modules;

2z7: Help; and

2z8: Reference.

The present technology provides for the issuance of a pass code or access code to the student upon completion of a concept 210 or group of lessons, or upon completion of a level. The pass code or access code can be input into an electronic device as an input signal, and if the code entered matches a predetermined access code, a student can be enabled to receive a subsequent lesson and progress to a subsequent concept 210 or concepts 210, or level, as provided by the program code. Those skilled in the art will appreciate that this approach allows the present technology to adhere to pedagogical methods that may be practiced in academia, but without the same rigidity of ordering of subject matter found within a common text book.

Within the example of FIG. 2, Concept 1 210a and concept 2 210b within a level do not comprise a group of concepts 210. The third concept comprises three concepts 210 or sub-concepts 210. In the example of FIG. 2 the student-user must complete the first concept 210a before moving to the second concept 210b. Once both concepts 210 are completed, the student-user may progress to the second level. Within the second level the student-user must complete the concepts 210 associated with three concepts 210 (i.e. demonstrate mastery of the subject matter of the lessons), before progress to a fourth concept 210c. Thus, in this example the third concept represents a group of concepts 210 that each has no prerequisites as to the others, but as stated, all of the sub-Concepts 210j, 210k, 210l within concept 3 are prerequisites to the concept 4. Concept 5, which is within level 3 comprises a concept wherein some sub-concepts, e.g., Concept 5.1.2 215f, have prerequisites and others, Concept 5.1 210e and Concept 5.2 210g, do not. Thus, while Concept 5.1 210e is a prerequisite to Concept 5.1.2 210f, Concept 5.1.2 210f is not itself a prerequisite to Concept 5.2 210g. However, concept 5.1.2 in the example of FIG. 2 is a prerequisite to concept 6. Consequently, while the order of completion of the sub-concepts 210 within concept 5 may be varied, all concepts 210 comprised within concept 5 must be completed, and concept 5 as a whole must be completed (i.e. mastered) by a student-user before the technology allows the user to progress to concept 6.

As disclosed above, each level is considered mastered upon successful mastered of the individual concepts 210 within it. The number of levels 205 required is informed by the content necessary to teach a course 206 as determined by the programmer. The technology provides that the mastery of all of the levels 205 is equivalent to the mastery of an entire course 206. Once an entire course 206 is mastered the technology can issue a pass-code to the user that he or she may input into an electronic device of the technology to enable receipt of a first level within a subsequent course 206.

The technology provides a student interface 215, or student-user interface 215. The student interface 215 comprises one or more interfaces 215 between a micro-application, separate instruction modules 270, a help function 280 and a reference 290, each of which will be described further within this disclosure. Additionally, the student interface 215 interacts with a student model 260, the student model 260 comprising a cognitive analysis algorithm 220, an updating function 230 and a problem generation algorithm 250. A problem generation algorithm 250 ensures that two or more different students learning the same concept 210 can be provided different problems when they study each concept 210. This allows students taking the same course 206 to meaningfully discuss subject matter with each other without the opportunity to simply imitate each other's answers. Within an implementation the discussion can occur via social media. Instruction modules 270 comprising an introduction, direct instruction, visualizations, summaries and reviews, are provided for each application via the student interface 215. Thus each module can instruct a student in each concept 210, can provide relevant examples of solutions (as visualizations for example) and thereby guide a student through the concepts 210 necessary for mastery of the concepts 210.

Each concept can be taught in a stand-alone application, and the type and amount of help provided to the student-user can depend upon the context of the concept being taught. However, the technology also provides the student-user with the option of accessing past help and past instructions should he or she feel the need to refresh. The reference 290 can be a database or databases containing instruction on many topics. The reference 290 can be accessible throughout each level so that a student-user may seek additional information to assist with the mastery of the concept in question. The reference 290 can contain all of the reference material that was provided during the teaching of past concepts 210, or the reference 290 can alternatively default to a set of predetermined entries relating to an application's concepts 210, or both options can be provided, depending on the amount of memory available on the hosting electronic device. Some or all of the reference material can be comprised within a remote database that can be communicatively coupled to an electronic device 100. Communicative coupling can be via a wireless network or by a physical connective network or other means.

Some student-users may not necessarily wish to utilize all levels as part of an overall course 206, but may instead choose to focus on certain levels. Thus the embodiment of the present technology provide for that option. However, when the applications are utilized within a course 206, the reference material can be provided through the student model 260 and update functions 230, or simply stored on an electronic device 100.

The student model 260 makes available to the application information that is provided by a student-user, but also provides information pertaining to the student's mastery level of each step within a problem being solved. Thus a student-user may be prompted that he or she has attained a certain skill level and may move on, or the student-user may be provided guidance relating to a portion of a problem or lesson that seems to be giving the student-user difficulty. The student-user may also be prompted to review particular portions of the reference 290 or the instructions 270, or other external sources for guidance. This overall didactic method allows individuals to proceed at their own paces, rather than at the single pace provided within a regular classroom setting.

The cognitive analysis algorithm 220 identified above interacts with the student model 260 to evaluate a student's understanding of a concept within an application. This allows for the adjustment of difficulty of problems. As a student-user learns and demonstrates mastery of concepts 210, the algorithm will adjust the information in a student model 260 regarding the student-user's mastery and understanding of the material. The cognitive analysis algorithm 220 and student model 260 within an application thus provide a more organic and holistic approach to teaching a subject than is provided in a regular classroom environment. The problem generation algorithm 250 generates new problems to be solved by the student-user. The parameters for a problem are randomly or semi-randomly generated based on static constraints (i.e. predetermined ranges of possible variables) and based on the information contained within the student model 260 (which contains information pertaining to the particular student-user). The problem generation algorithm 250 generates a problem containing at most a single step which a student has not yet mastered. As intimated above, the problem generation algorithm 250 generates a new problem each time it is invoked and, with reference to the data previously collected about the student-user in an application, adaptively increases problem complexity related to a concept 210. This allows for a graduated increase in overall difficulty as each step is mastered within the problem solving procedure.

Each time the student completes a problem presented within an application the update function 230 is invoked (or called). The invocation of the update function 230 updates the student model 260 with information relating to a student-user's individual performance on the last problem completed. If a student successfully completes a problem the update function 230 raises or increments a score of the student mastery level. Successful completion of a problem is demonstrated by a student-user though his or her selection of response options matching an answer to the problem within a lesson. The correctness of the selected response option is displayed to the student-user and recorded within the student model 260. When a student fails a problem, through the selection of response options which do not match an answer generated by the problem generation algorithm 250, the update function 230 lowers or decrements a score of the student mastery level. The correctness (i.e. the rightness or wrongness) of a selected response is recorded within the student model 260 and can be displayed to the student-user via a visualization.

Embodiments of the technology provide that an application can be so configured to interact with a student account stored in a database exterior to the electronic device 100 running an application. A database may comprise one or more databases. The database may be accessible through the internet or a wireless network. The database may be so configured to interact with one or more websites which may be used to record and display student progress. Student progress can include indications of how well a student understands a topic. A website may display suggested help topics, as well as show the next topic provided by a course 206. A website can also display a listing of those concepts 210 available to a student within a course 206 and what levels the student-user has completed. The website can display information pertaining to a student's overall mastery of a subject, suggest areas or concepts 210 for further review, and display information as whether or not the student is ready to complete testing to certify completion of a course 206. The application running on an electronic device 100 will interact with the data in a student account via one or more update functions 240.

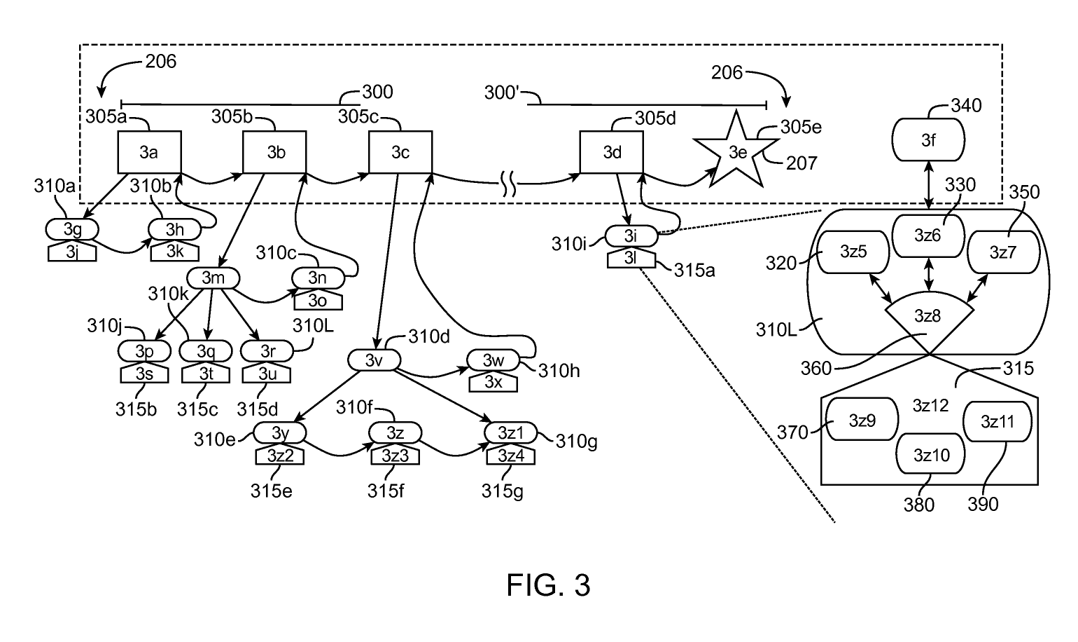

Consider the presentation of a particular course 206, physics, using the present technology. In the example shown in FIG. 3, the course 206 subject is presented in a form of a role playing game. As a student-user advances through the levels 305 of the game he or she is taught the subject. In the example of FIG. 3, once the student-user, or “player,” reaches the ultimate objective of the game 207, he or she will have concomitantly been taught an entire course 206. In this example, levels 305 are connected via a common overarching story 300. In one possible example of a story 300, a player travels back in time to learn a subject from a character representing the men and women that contributed to the advancement of the course 206 subject. Thus in the example pictured in FIG. 3, the student can learn from a virtual Galileo Galilei, a virtual Isaac Newton, and other persons significant to the development of the subject, such as a virtual Albert Einstein. Each of the levels 305 corresponds to a time period important to the advancement of the subject being taught. Each game level comprises a setting in which one or more concepts 310 or lessons may be taught using the methods described above. Within this disclosure, an electronic device 100 may be so configured to allow a student user (player) to advance to a subsequent level only after a player demonstrates mastery of all of the concepts 310 within a level. An electronic device 100 may also be configured to allow a player to utilize levels 305 independently from one another, regardless of what levels 305 have been previously completed.

Continuing with the example depicted in FIG. 3, each of the concepts 310 comprised within a level corresponds to multiple physics problems. All of the physics problems in a given level are solved using similar procedures. Each of the concepts 310 has its own story fitting within the overarching common story 300 referenced above. Each concept or lesson is a stand-alone application or game to be stored on computer readable media and executable on an electronic device 100. The methods herein provide for as many games as are necessary to teach an entire course 206. As set forth with regard to the example from FIG. 2, some concepts 310 have prerequisites. The satisfactory completion of a prerequisite will cause the technology to create an access code to be input by a student user to enable the receipt of a next subsequent lesson. Advancement to the next level can be signaled by a “time-travel event” displayed on the display of an electronic device 100. Other means of signaling advancement are possible within this disclosure. Correspondingly, the mastery of all concepts 310 within a game level will produce an access code to be entered into an electronic device 100 by a player for enabling the receipt of a next lesson within a next level. The number of games programmable into an electronic device 100 will depend upon the number of subjects contained within a course 206. The object of the game shown in the example of FIG. 3 is for the player to return to his own time, which may be considered the present, though other options are available within this disclosure. The player advances through various time periods corresponding to levels 305 in sequence in order to return to the players' own time. Embodiments of the technology provide that in order for the player to advance to his own time the player must demonstrate mastery of the subject of the course 206 by completing the games associated with the concepts 310 provided.

Referring to FIG. 3, the following identification numbers correspond to the following text as follows:

3a: Level 1 Home;

3b: Level 2 Galileo's Time;

3c: Level 3 Newton's Time;

3d: Level n Einstein's Time;

3e: Level n+1 Home;

3f: Course Update Function;

3g: Concept 1 Story 1;

3h: Concept 2;

3i: Concept n Story n;

3j: Student Interface;

3k: Student Interface;

3l: Student Interface;

3m: Concept 3;

3n: Concept 4 Story 4;

3o: Student Interface;

3p: Concept 3.1 Story 3.1;

3q: Concept 3.2 Story 3.2;

3r: Concept 3.3 Story 3.3;

3s: Student Interface;

3t: Student Interface;

3u: Student Interface;

3v: Concept 5;

3w: Concept 5 Story 6;

3x: Student Interface;

3y: Concept 5.1 Story 5.1;

3z: Concept 5.1.2 Story 5.1.2;

3z1: Concept 5.2 Story 5.2;

3z2: Student Interface;

3z3: Student Interface;

3z4: Student Interface;

3z5: Cognitive Analysis Algorithm;

3z6: Update Function;

3z7: Problem Generation Algorithm;

3z8: Student Model;

3z9: Instruction Modules;

3z10: Help;

3z11: Reference; and

3z12: Student Interface.

The playing of games and lessons described results in visualizations using original or unoriginal art and corresponding to the correctness of selected response options. Consider for example a game that teaches how to solve the equation necessary to calculate the trajectory of a space ship landing on the moon. If the student enters valid responses, (indicating the student understands the problem), a space ship can safely land. Conversely, if incorrect responses are selected the space ship can crash or miss the intended target.

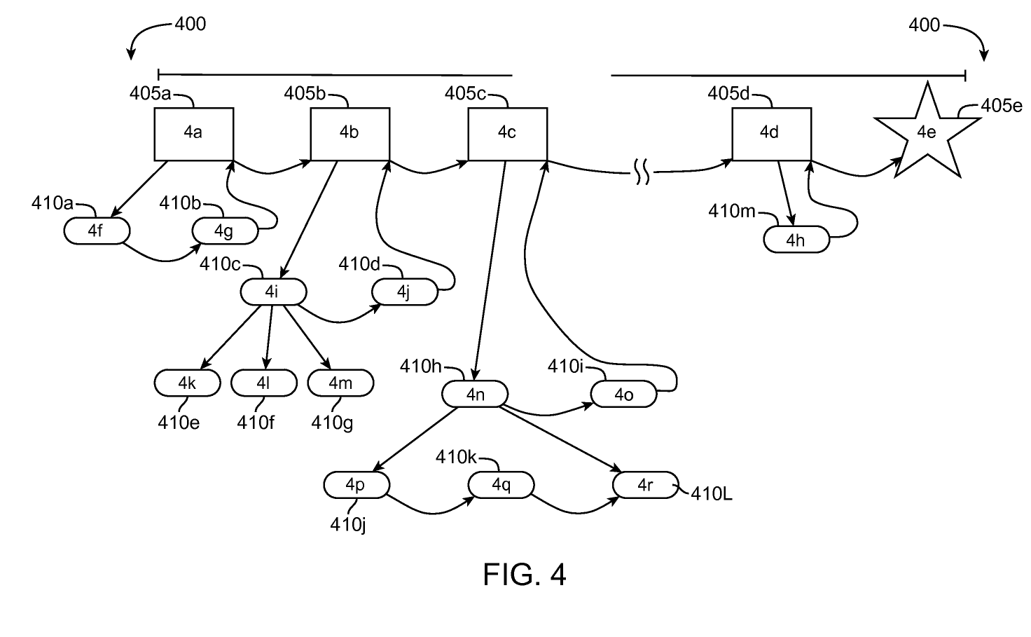

As shown in FIG. 4, it is contemplated that the interactive teaching methods of the present technology can be used by the student-user in conjunction with a set of texts stored and readable on an electronic device 100. The electronically provided text or texts could provide content relating to virtually any subject, just as the methods described herein may be used to educate a student-user in virtually any subject. Thus a complete course 206 curriculum 400 could be presented. A curriculum 400 is subdivided into chapters 405. Chapters 405 may be presented which parallel the levels 205 described in the methods above. Each of the individual chapters 405 within a text or texts may comprise one or more sections 410. The student-user is required to view all of the text within a section 410 before being allowed to access the next section 410. Similarly, the student-user may be required to view all of the sections 410 within a chapter 405 before being allowed to access the next chapter 405. Each of the sections 410 will reside within a stand alone application or applet within an electronic device 100. Each section 410 may be related to chapter 405 curricula 400, which may parallel a part of a course 206 presented within one of the methods described above. Sections 410 could be made available separately allowing a course to be customized.

Referring to FIG. 3, the following identification numbers correspond to the following text as follows:

4a: Chapter 1;

4b: Chapter 2;

4c: Chapter 3;

4d: Chapter n;

4e: Chapter n+1;

4f: Section 1;

4g: Section 2;

4h: Section n;

4i: Section 3;

4j: Section 4

4k: Section 3.1;

4l: Section 3.1;

4m: Section 3.3;

4n: Section 5;

4o: Section 6;

4p: Section 5.1;

4q: Section 5.1.2; and

4r: Section 5.2.

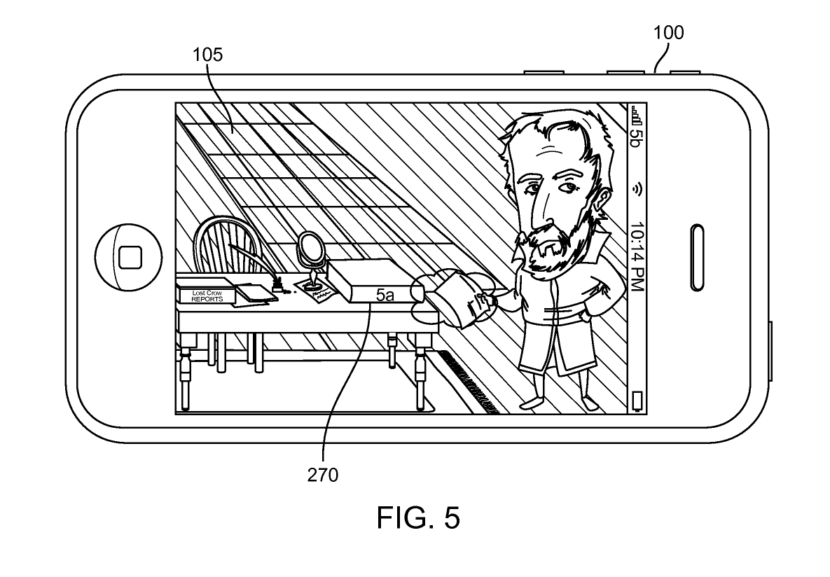

Reference will now be made to an example in which the student-user receives instruction in physics from Galileo, as illustrated in FIG. 5. (The following identification numbers correspond to the following text as follows: 5a: Instructions; 5b: Carrier). Galileo is shown on a graphical user interface 105 on an electronic device 100. Galileo is depicted standing before a table, holding a parchment. On the table is an image of a book corresponding to instructions 270 which the student may access by tapping a cursor or by contacting an input device on the electronic device 100. Galileo is depicted in a room. Depending on the magnification level or zoom level of the display on the electronic device 100, all of the room may not be viewable by the student-user at any one time.

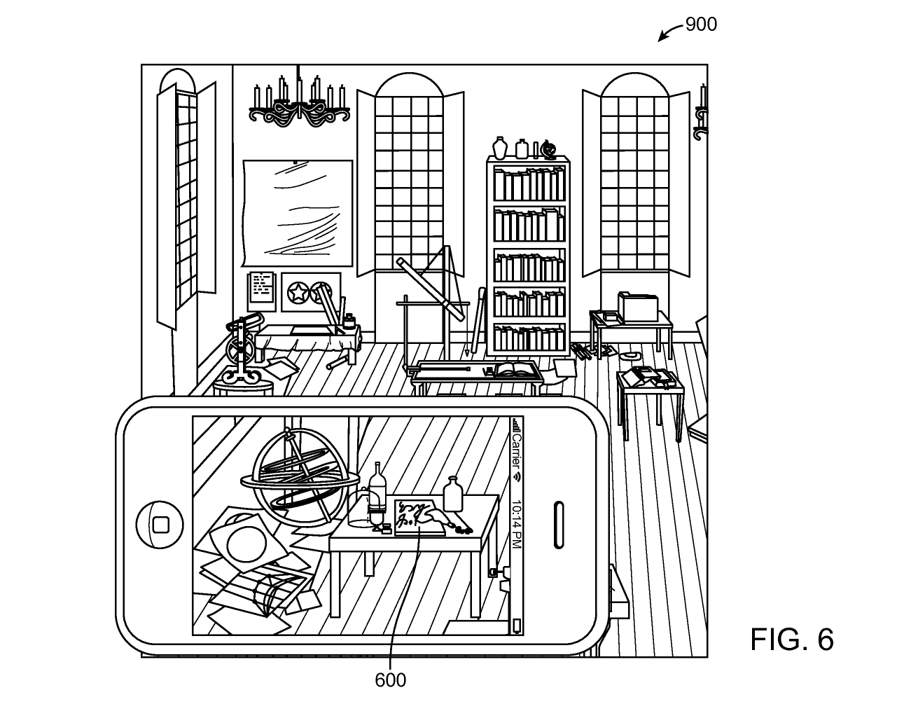

The student-user is provided with the ability to pan the view to other portions of the room, as depicted in FIG. 6. Pan, zoom and select functions can be implemented in various ways. Depending on the exact configuration of an electronic device 100, panning and zooming may be caused by a user through the depression of direction keys, +/− bars, contacting a touch pad, or moving a mouse across a surface. Other possible user input devices include, but are not limited to, knobs, dials, jog-dial, arrow keys, track balls and touch-sensitive screens. In the image shown in FIG. 6 there is an image of a story book 600 resting on a table. The story book 600 can be selected and opened via an input mechanism on the electronic device 100.

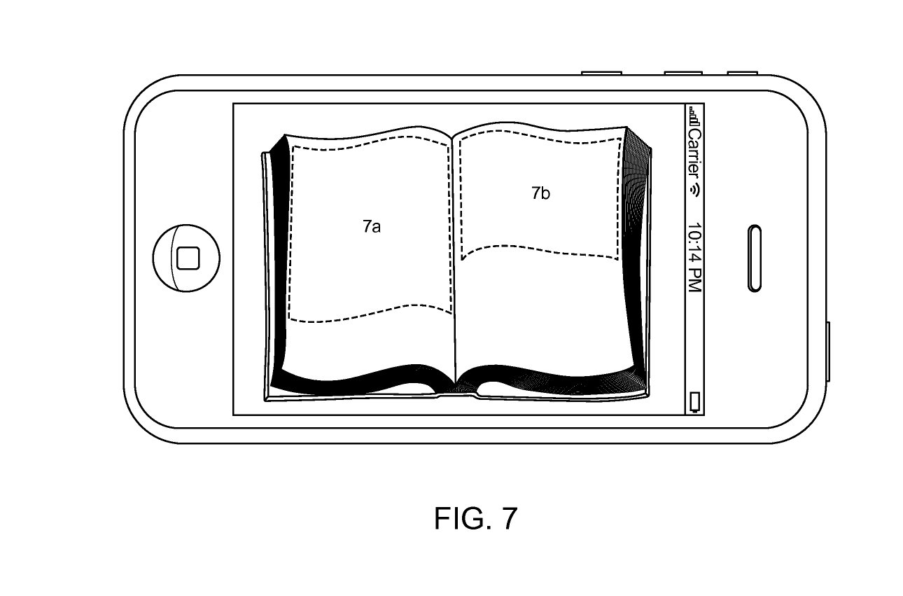

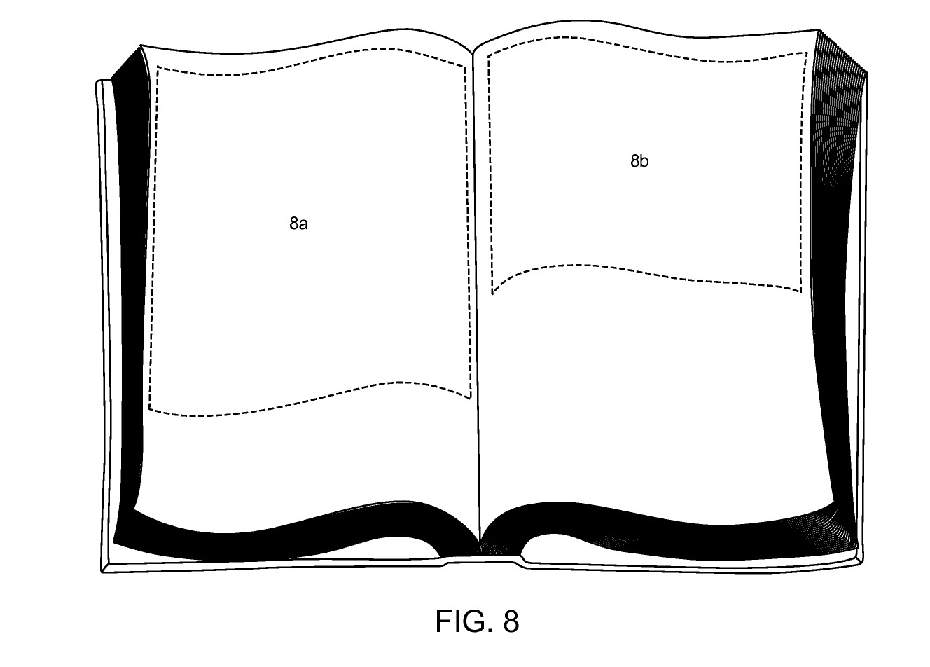

Selection of the story book 600 yields images of the pages of a book as shown in FIG. 7 and FIG. 8. The identification number 7a and 8a contains the following text:

The identification number 7b and 8b contains the following text:

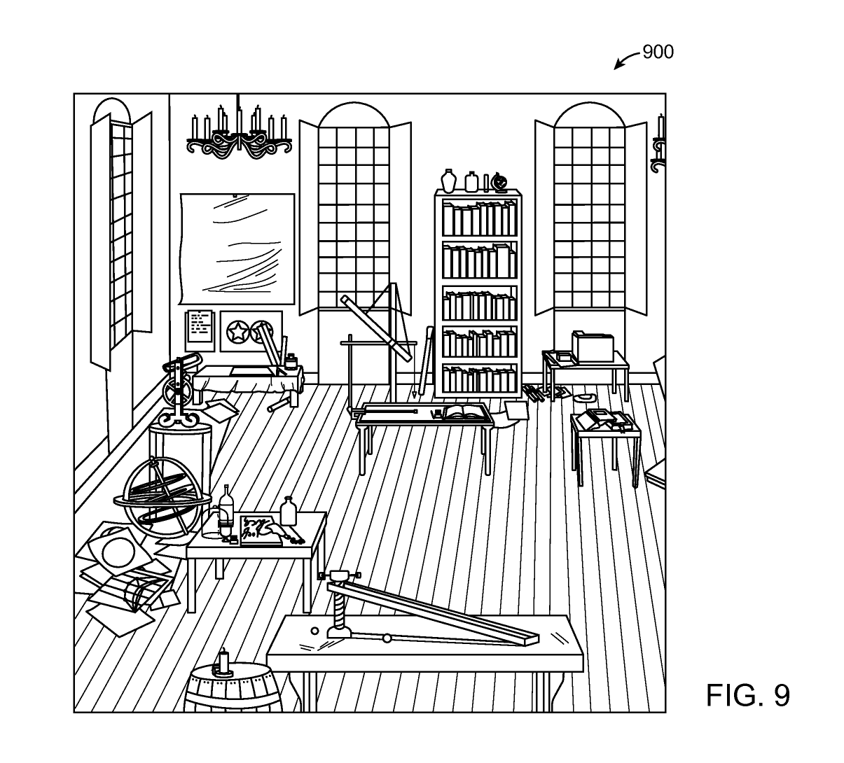

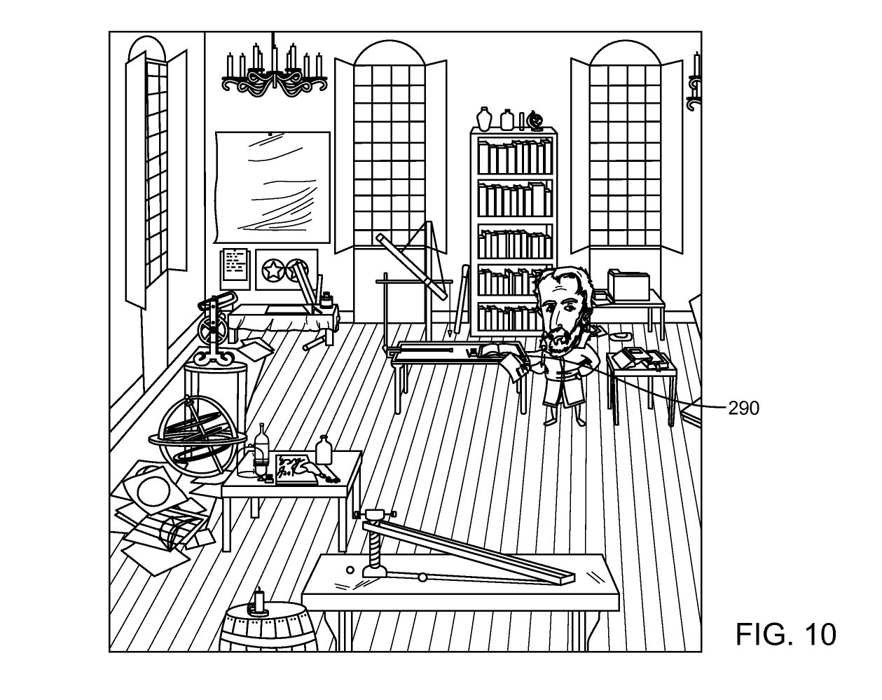

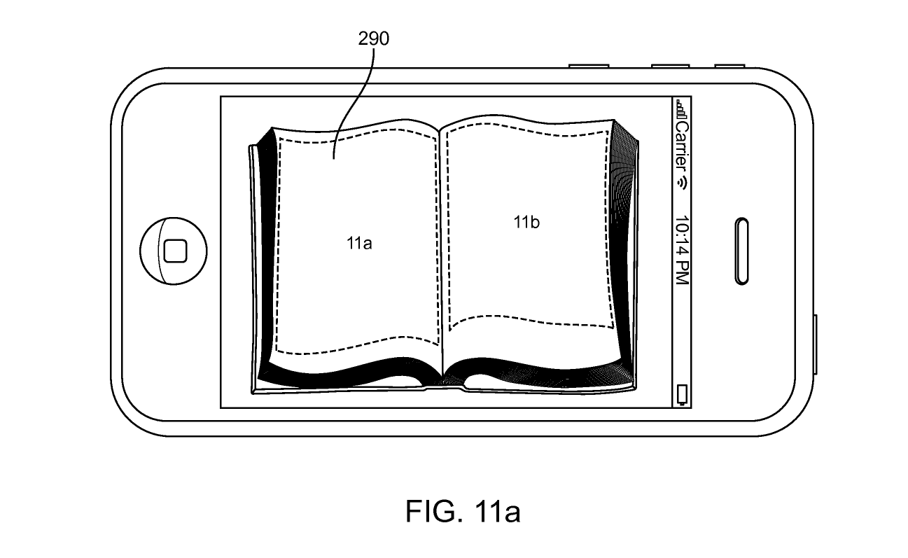

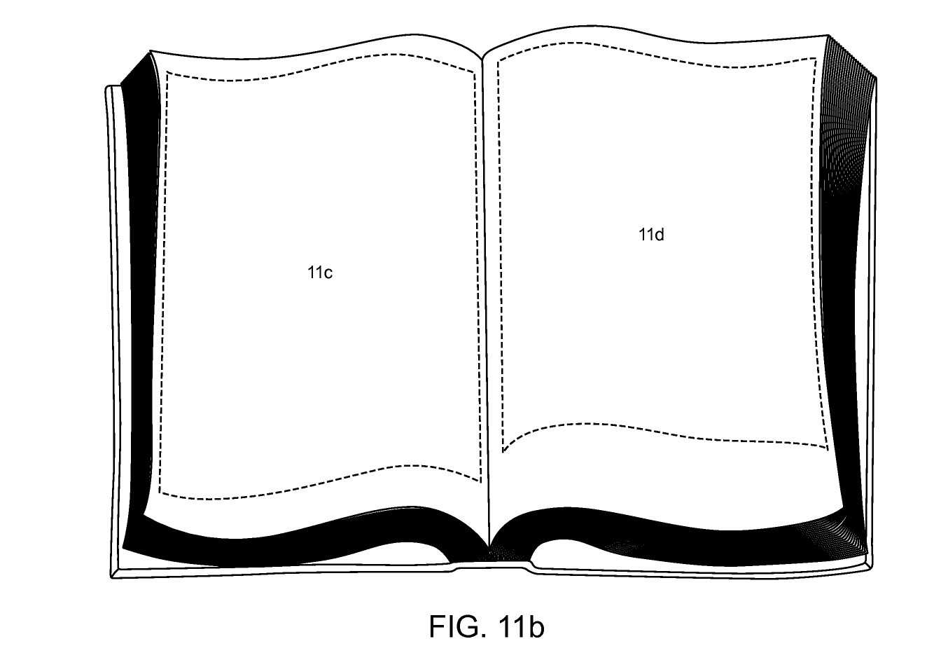

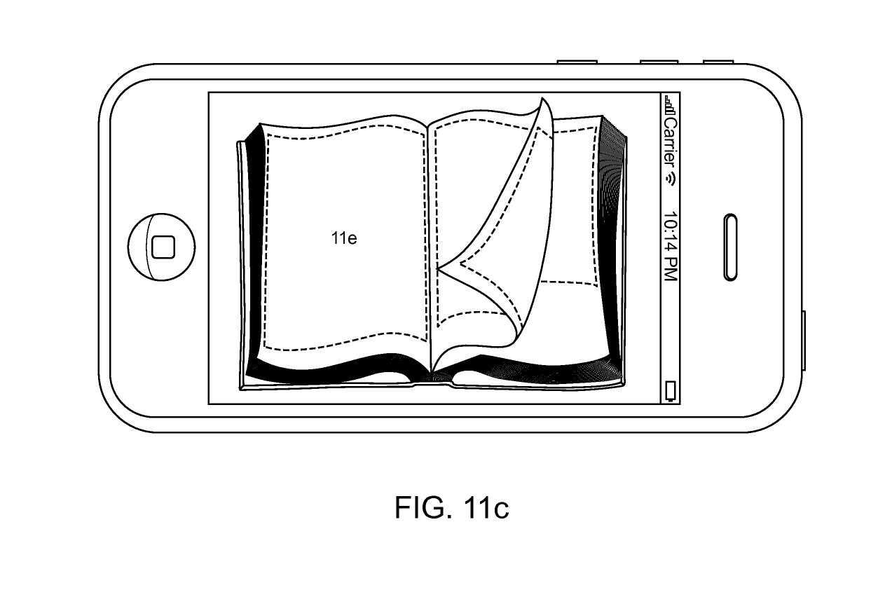

In the particular embodiment shown in FIG. 8, the student-user is able to read a narrative of how his character arrived at the current point in the story 300, or another book may be available for the student to read which may be a journal which the student-user has compiled into the story 300. As described above, in this example the student-user is presented with a large room 900, as depicted in FIG. 9. The room is 3-dimensional. Different selectable items within the room may correspond to different concepts 210 and learning objectives. The student-user may change the position of the character to different places within the room by inputting data on the electronic device, as shown in FIG. 10 or the character may move to different places within the room based on concepts 210 which have been completed by the student-user. In FIG. 10 the character is shown adjacent to a user-selectable item depicting a reference 290 book. By selecting the reference 290 book the student user is able to access textual images explaining the relevant points of a subject being studied by the student-user, as shown in FIG. 11a, FIG. 11b and FIG. 11c. Identification number 11a, 11c, and 11e correspond to the following text:

Identification number 11b and 11d correspond to the following text:

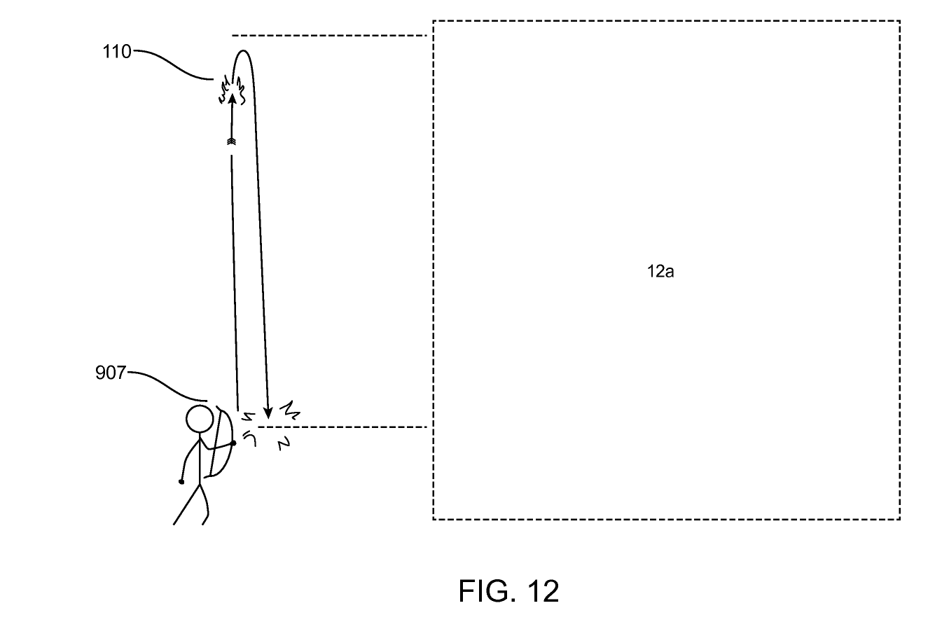

FIG. 12 depicts an example of a lesson which is a visual lesson 110 within this disclosure. The identification number 12a contains the following text:

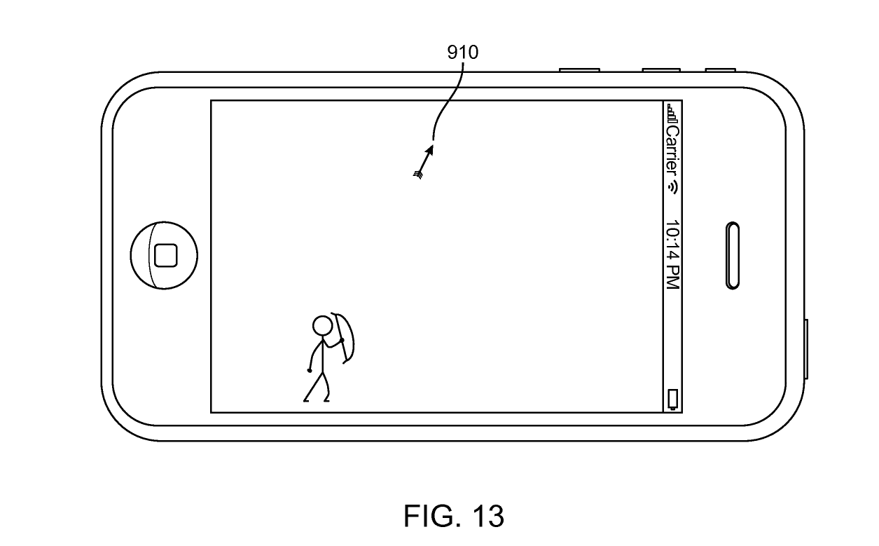

The visual lesson 110 begins after the student-user selects a selectable object within in the room, such as a paper or chart the character is holding, papers on the floor, or a book like the one shown in FIG. 5. It will be noted that the visual lesson 110 and the visualization which accompanies it are presented in a two dimensional format on the display of an electronic device 100, whereas other parts of the story 300 may be presented in a three-dimensional format. In the lesson the student-user is presented with a problem to solve. As intimated above, the difficulty of the exact problem being presented to a student-user will be adjusted within a student model 260. Once the student-user has entered values on the graphical user interface 105 of the electronic device 100, a visualization 910 corresponding to the correctness of the student's answer is provided, as shown in the example of FIG. 13. The example depicted in FIG. 12 is an example of an “up-down” problem. In this type of problem, an object is travelling straight up at a known velocity with the only external force being gravity. In this example, the student learns how to calculate the maximum height of an arrow fired from a bow 900. At time zero (t=0) the position of the arrow is zero (0) meters. Given this information, a student-user solves for the maximum height of the arrow and the time the arrow is in the air. The student user may then enter his individual responses or values for his proposed answers. The display screen of the electronic device 100 will then display a visualization 910 indicating the rightness or wrongness of the values supplied by the student-user. By working through multiple visual lessons 110, and viewing visualizations 910 corresponding to the correctness of the responses selected or data entered by a student-user, a student-user is taught the lessons to learn the subject matter of a course 206, or part of a course 206.

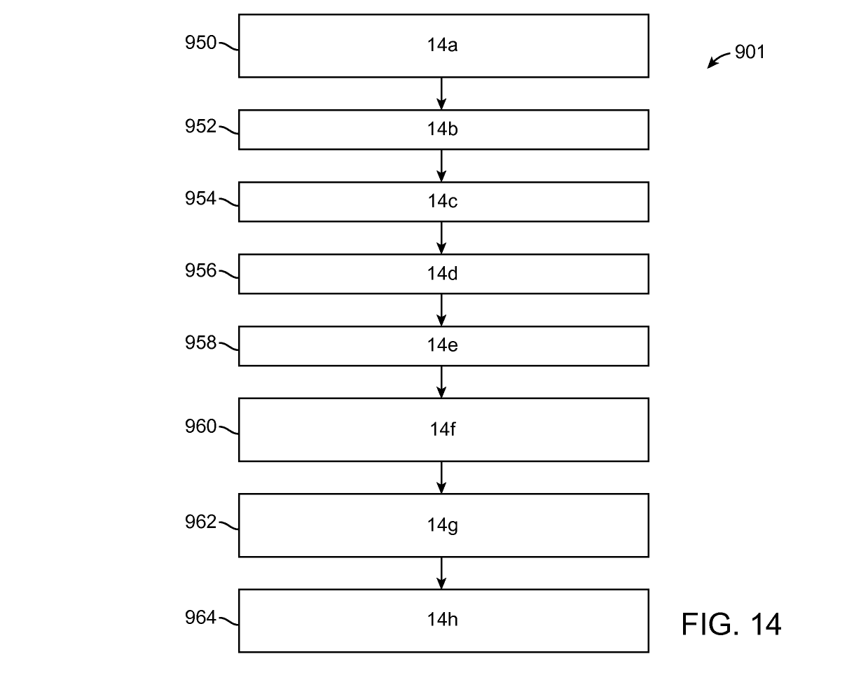

The flowchart FIG. 14 depicts a method 901 for teaching lessons within an electronic device 100. In block 950 an input signal is received indicating a request for a lesson. The input signal may be input via a graphical user interface 105, a keyboard (not shown) or other data entry device on an electronic device 100, such as touching or tapping a touch-sensitive display screen. In block 952 data is received by a processor on an electronic device 100 which includes executable code within a student model which may comprise a cognitive analysis algorithm 220 and may require execution of a problem generation algorithm 250. In block 954 data is executed on a processor of an electronic device 100. In block 956 a graphical user interface is displayed. In block 958, a student-user is provided with one or more response options, which may include selection from one or more possible selections or entry of data through a data entry device on the electronic device 100. Upon entering data or selecting one or more of the response options, an input signal is received by an electronic device 100, in block 960. In block 962 a determination is made regarding of the correctness by determining if a selected response or data entered matches an answer to the visual lesson 110 within the student interface 215. An electronic device 100 may be so configured as to create an access code upon completion of a predetermined set of lessons. Depending on the nature of a course 206 or the needs of a student-user as determined by course 206 instructor, the access code may be required to be entered as an input signal or signals in order for a student-user to access another lesson to learn another concept 210, or to enter another level 205, or to receive another course 206.

Referring to FIG. 14, the following identification numbers correspond to the following text as follows:

4a: RECEIVE A FIRST INPUT SIGNAL INDICATING A REQUEST FOR A LESSON;

4b: RECEIVE DATA FOR AT LEAST ONE VISUAL LESSON;

4c: EXECUTE THE DATA PROCESSOR OF THE DEVICE;

4d: DISPLAY A GRAPHICAL INTERFACE;

As has been noted above, the examples described herein and the figures presented above are by way of example, not limitation. Those skilled in the art will recognize that it is one aspect of the technology that students are required to master qualitative reasoning and quantitative problem solving. Implementations of the technology can be characterized by a network of topics or concepts related to each other via a prerequisite network of prerequisites (in this case one topic). Players or students of embodiments of the technology can advance through the game through the exercise of ingenuity and problem solving skills.

Implementations of the technology may include, but are not limited to, the following components: “Lessons”: Lessons can include interactive computer-based instructional modules necessary to support navigation of the adventure game world including in-game quests; “References”: References can include a topic-based encyclopedia of the material addressed in the game. The reference is organized around topics. Topic names serve as both index and search terms for the reference. Associated with each topic are one or more entries. Entries may consist of text, visualizations, and hyperlinks to other entries or external resources; “Organizers”: When a player enters an episode, an introduction or advance organizer for the episode's core concept may be presented. When the player leaves a level, a review or summary of the episode's core concept may be presented; “Help”: The environment provides hints that progressively disclose more information with each request. Requests can: 1) reference applicable scientific principles, 2) classify the problem and describe the solution path, and finally 3) solve the problem, reveal the solution, or provide explicit instructions; “Player Interface”: An interface is required to integrate the game and its instructional support. The primary interface can be an accelerometer-directed input and can be a HUD in 2D game space, and can include other interfaces.

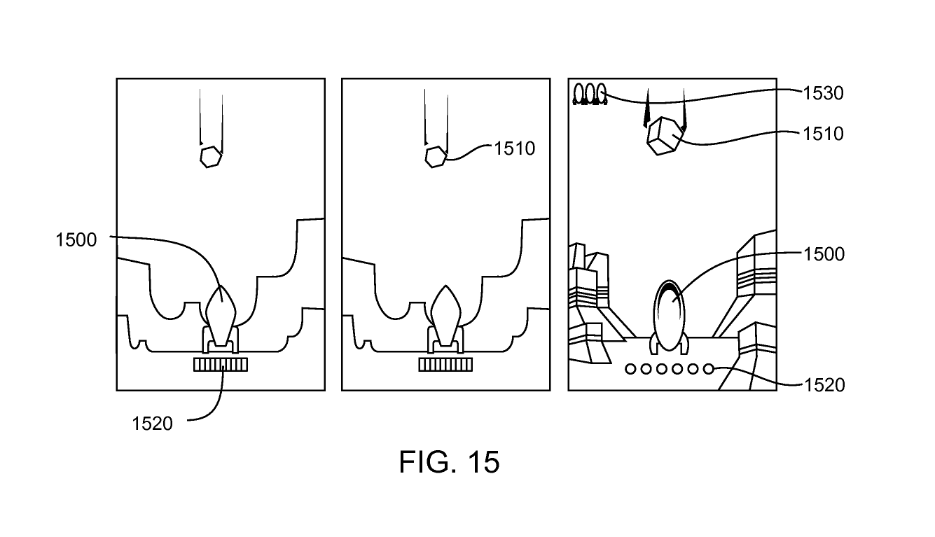

An example implementation of the technology is a game called Escape from Unitopia, as illustrated FIG. 15. In the game Escape from Unitopia, the planet Unitopia is passing through a storm of cosmic debris 1510, resulting in a lethal shower of basic quantities and units. A student-player may save the inhabitants of Unitopia by collecting appropriate units of fundamental quantities (e.g., kilograms—mass). These units fuel the ship 1500. Once a ship 1500 has been filled completely with the appropriate fuel, it launches into space and the people within are rescued. Overfill the ship 1500, or feed it the wrong type of fuel, and it is diminished or even destroyed. The scene starts with a single stylized spaceship on a flat alien landscape. The screen shakes; the ground cracks, and dozens of small figures rush into the ship 1500 and close the door. The sound of an engine turning over and failing to start is heard. (e.g., humorous—the sound a 57 Chevy turning over, but failing to start). Tiny voices can be heard raising the alarm. “Oh no—out of fuel!”

Game play begins as meteors 1510 begin to fall from the top of the screen toward the ground. They are slow and single at first. There are 7 (or more) meteor types, each with an icon (or the scientific symbol) representing a unit of measurement. If the player fails to fuel the ship 1500 in time, overfills it, or allows inappropriate quantities to touch the ship, it is destroyed (or fuel is depleted). Game play continues, with successive levels increasing in difficulty by tweaking certain key variables:
Number of ships
Size of ships
Speed of falling components (meteors)
Increased variety of falling components (meteors)
Skew the balance of appropriate vs. destructive components (meteors)
Concavity of the landscape—Basically the flat landscape can become more valley-like (u-shaped) with up to 4 ships on opposite sides of the valley. This would require more dynamic turning of the iPhone to deliver fuel to the ships.)
Ship may require multiple derived units for fuel (e.g., meters and seconds m/s)

Continuing with the Unitopia example, beneath the spaceship 1500 is a symbol 1520, with a number, indicating the type and amount of fuel required to launch the ship. At the top of the screen are icons 1530 and/or counters indicating the number of available ships or lives remaining. The player may rotate an electronic device using the accelerometer to control the direction of the falling pieces. The object of the game is to fill the ship's 1500 tanks with the appropriate components by combining units to reach the specified amount. For example, one of the easy levels would be to fill the solar ship with 10 candelas of luminosity. This could be done with whole candelas, or combining smaller units whose sum is a whole. It may be possible to shoot incoming meteors thereby eliminating irrelevant units or breaking up relevant units into smaller pieces to meet fuel requirements.

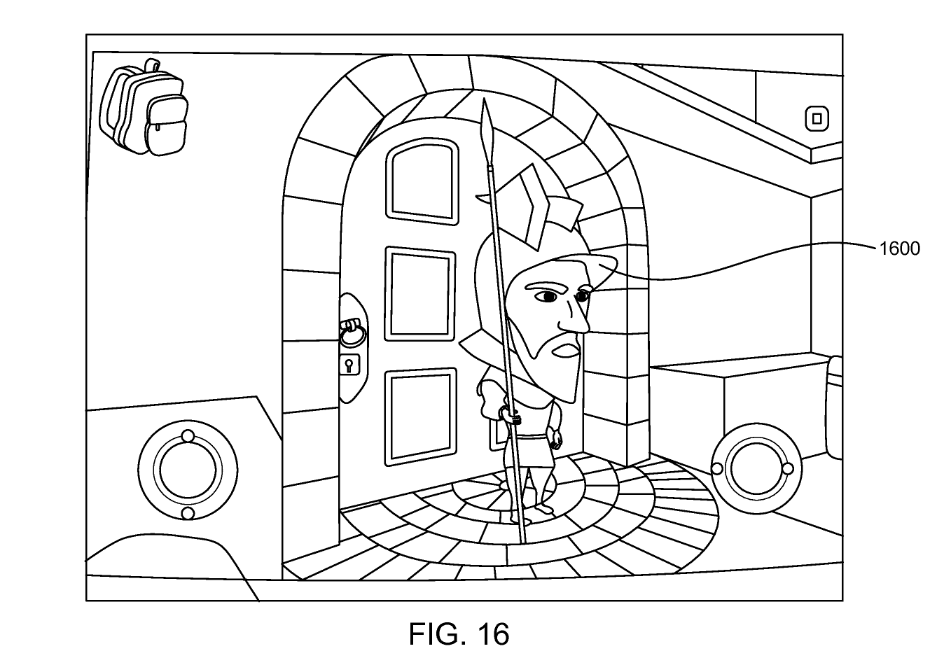

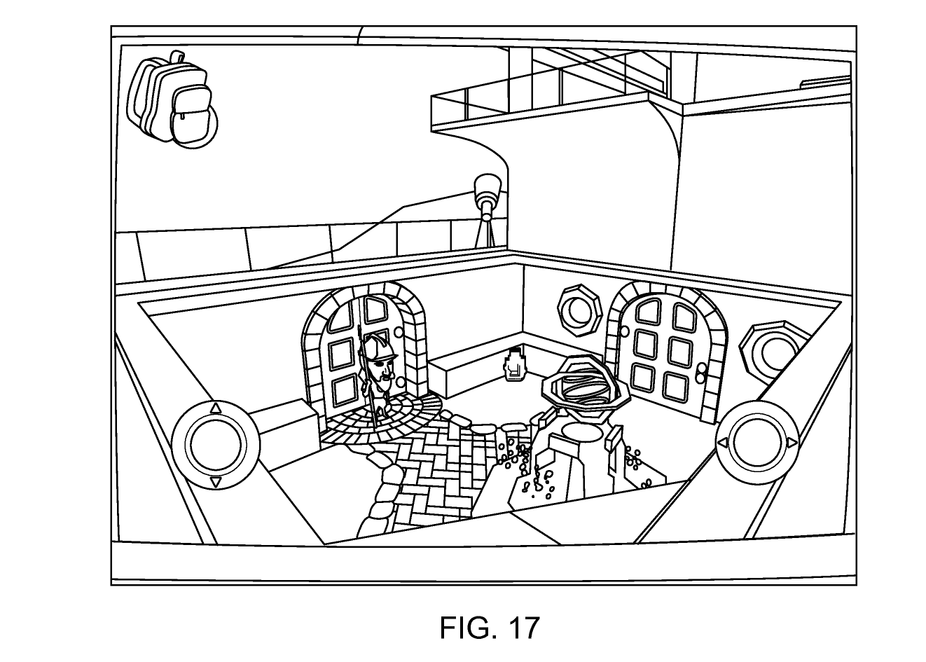

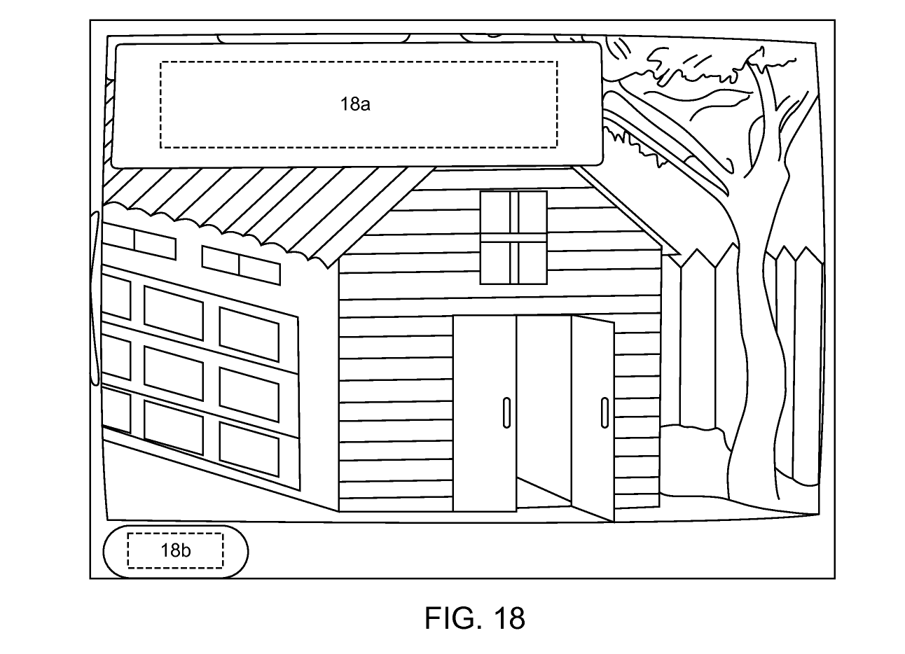

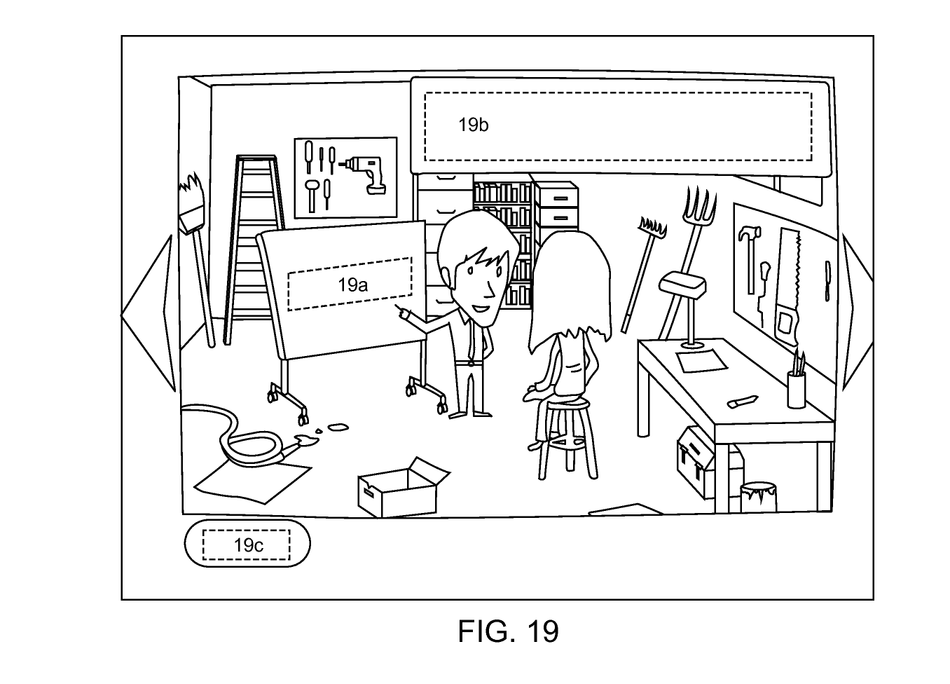

In various implementations of the technology, an adventure game world may be structured in accordance with each lesson to be taught. An adventure game world may be populated with objects, actors (e.g. 1600), actions, and events that direct activity and host educational content, as depicted in FIGS. 16-19. Objects, or props, can be placed appropriately throughout a game world in accordance with the technology. Objects or props may provide explicit instruction, supportive reference, contextual help, or merely further the story. Likewise, non-player characters (NPC) (e.g. 1600) may be strategically placed around a game space to lead player-students in authentic learning activities or Paper Plays™. As discussed above, components can be linked by an intra-episode storyline that is informed by a set of formalized instructional design requirements and a larger narrative. Referring to FIG. 18, the following identification numbers correspond to the following text as follows: 18a: It's a warm spring day in Fairhaven. Instead of playing outside, Keagan is learning about Physics in his Dad's workshop; and 18b: SKIP. Referring to FIG. 19, the following identification numbers correspond to the following text as follows: 19a: F=m*a=>a=F/m; 19b: Keagan tries to understand what her father is teaching, but learning physics has always been a chore; and 19c: SKIP.

In another aspect of the technology, a module designed to teach scientific units of measurement is provided. Modular lessons in Newtonian mechanics, fluids, thermodynamics, electricity, magnetism, optics, waves, atomic physics and nuclear physics can be provided. Together these lessons and episodes can form a game world. Each episode can teach a set of focused learning objectives using fluid game play, embedded instruction, guided discovery, and directed problem solving. Implementations of the technology can foster learning by creating an engaging and supportive environment for the authentic exploration of key concepts, principles, and relationships in physics using game-based learning. Fluid game play, embedded instruction, guided discovery, and directed problem solving can be wed to form a unique and productive learning environment for physics or other topics. Within the technology, some learning comprises memorization. Memorization may be imparted by the technology by embedding learning opportunities in game play such memorization naturally flows from the attempt to meet game goals.

There are a number of issues for teaching units. These include measurement, standardization, scaling, and conversion. In some implementations of the technology, a student will be taught to match fundamental quantities with corresponding units of measure (both standard and non-standard) using the SI system. A student-player may also be to differentiate between unit prefixes. Additionally, a student-player will be taught to differentiate between base units and derived units.

As discussed above, Paper Plays™ may be provided with a wrapper that manages player login, character selection, and data storage. A HUD may be provided to show a fuel gauge and other information. Additionally, a control scheme may be provided whereby a player controls the motion of falling objects by titling the device. A fire button may be employed if a weapons system is scoped in the development plan. Standard GUI components will be used for menuing, paging, and general navigation.

In various implementations of the technology, in order to enhance fluidity of game play, levels may be arranged in a meaningful way. Arrangements may include, but are not limited to:
Random—Quantities/ships are selected at random. This allows for increased variability in game play, but might result in an unequal distribution of quantity/units viewed by the player. Random level sequencing maps advantageously to free play.
Sequential—Quantities/ship are selected in turn, one quantity after another in lock-step fashion. This approach ensures that each item is addressed is a systematic fashion, but might reduce replayability. If this campaign approach is employed, a simple story line could introduce the reason for the sequence and levels of difficulty.
Player-Controlled—Players are free to select a quantity/ship of their choosing. This approach engages the player, but does nothing to ensure the player sees all quantity/unit pairs and requires development of a mechanism for selecting ships. Player control might be an unlockable available only after the player has passed some threshold of mastery.

Difficulty—Various difficulty levels are presented hereinbelow.
Difficulty 1—Action begins with an average of 2 meteors onscreen at a time. New meteors spawn once every 2 seconds. 60% of all meteors spawned are of the target type. There is one ship onscreen. Each quantity/ship begins with this level.
Difficulty 2—Action begins with an average of 3 meteors onscreen at a time. New meteors spawn once every 1.5 seconds 50% of all meteors spawned are of the target type. There is one ship onscreen.
Difficulty 3—Action begins with an average of 4 meteors onscreen at a time. New meteors spawn once every 0.5 seconds. 40% of all meteors spawned are of the target type. There is one ship onscreen.
Difficulty 4—Action begins with an average of 2 meteors onscreen at a time. New meteors spawn once every 2 seconds. 60% of all meteors spawned are the target type. There are two ships onscreen.
Difficulty 5—Action begins with an average of 3 meteors onscreen at a time. New meteors spawn once every 1.5 seconds. 50% of all meteors spawned are the target type. There are two ships onscreen.
Difficulty 6—Action begins with an average of 4 meteors onscreen at a time. New meteors spawn once every 0.5 seconds. 40% of all meteors spawned are the target type. There are two ships onscreen.
Difficulty 7—Action begins with an average of 2 meteors onscreen at a time. New meteors spawn once every 2 seconds. 60% of all meteors spawned are the target type. There are three ships onscreen.
Difficulty 8—Action begins with an average of 3 meteors onscreen at a time. New meteors spawn once every 1.5 seconds. 50% of all meteors spawned are the target type. There are three ships onscreen.
Difficulty 9—Action begins with an average of 4 meteors onscreen at a time. New meteors spawn once every 0.5 seconds. 40% of all meteors spawned are the target type. There are three ships onscreen.
Difficulty 10—Something with derived units?

Toggling meteor unit icons/scientific abbreviations and modifying the landscape may also manipulate difficulty. There are a number of possible ways to make an implementation more challenging. For example, the icons and abbreviations might be revealed only after a meteor 1530 is touched. An electronic device or software running on a device may be configured to make this an unlockable event and which only becomes available after a player has demonstrated a predetermined level of mastery of a subject.

Again, referring to the Unitopia example discussed above, A Pause Menu may be available to the player. It allows the player to replay the opening scene, review the story, examine game progress, peruse any of the mini instructional modules (MIMs), change game options, and quit. Once activated, game play is paused while the player explores the available options. An implementation of the technology such as the Unitopia example may contain the following features:

Fuel Management—Ship 1500 fuel tanks may vary in size depending on the difficulty of the current level. The following rules may apply:

Correct unit (standard)—If the player collects a unit appropriate to the ship's 1500 mission AND the unit is the SI standard, then the tank is incremented by the unit's prefix value.

Correct unit for quantity but non-standard—If the player collects a correct, non-standard unit, the tank remains unchanged. An example would be hours for time.

Incorrect—If the player collects an incorrect unit, the tank is decremented by 1/10 of the tank's capacity.

Other modifiers—Other multipliers may be employed that increase or decrease a meteor's fuel value (e.g., rescuing Unitopians).

Scoring—A single score is used to provide the player with feedback about game performance. The following rules may govern score:

Score is initially set to zero.

For each correct standard unit collected, score is incremented by 10 points.

For each correct non-standard unit collected, score is incremented by 1 point.

For each level completed, the player is awarded 100 points.

A perfect level score awards an additional 1000 points. A perfect level score results when the player captures all correct standard units and does not collect any other units. Depending on fuel tank parameters, a perfect score may or may not be possible for a given level.

Achievements—Achievements are rewards presented during game play for various accomplishments. Some are easy to attain, while others are difficult. Achievements appear onscreen as a small popup and in lists on the Progress page. Achievements can persist across sessions.

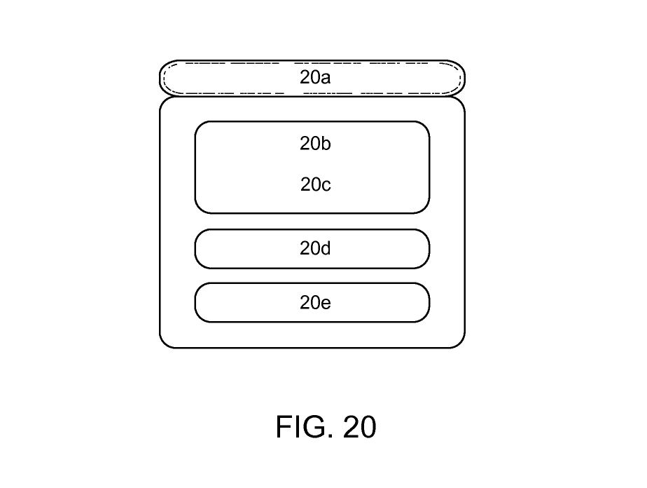

In one implementation of the technology, a user-player may begin by logging in to his or her account or by creating a new account, as illustrated in FIG. 20. Referring to FIG. 20, the following identification numbers correspond to the following text as follows: 20a: SIGN IN; 20b: NAME: _ _ _; 20c: EMAIL _ _ _; 20d: LOG IN; and 20e: NEW USER.

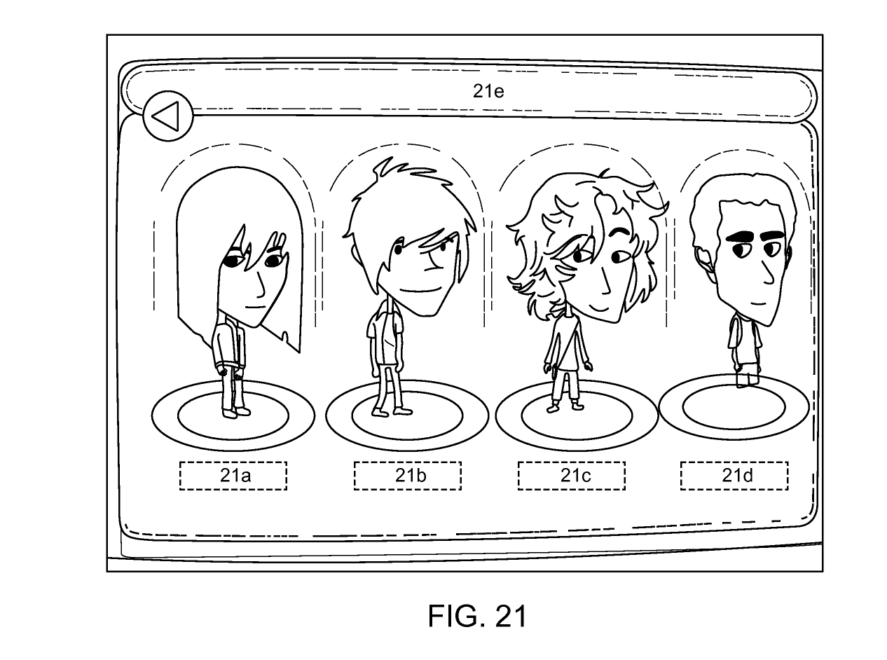

In one implementation of the technology, a player-student may select a player-character, as illustrated in FIG. 21. Referring to FIG. 21, the following identification numbers correspond to the following text as follows: 21a: KEAGAN; 21b: ALEX; 21c: BAYLEE; 21d: HASSAN; and 21e: CHARACTER SELECTION.

In at least one implementation of the technology, when a user selects a non-playing character, a user environment may switch to a conversation system. A conversation system may comprise: a 3-dimensional display toggle selector; a camera switch which can allow a character to be viewed from a dynamic view; a conversation GUI, wherein text may be entered or displayed and other possible options.

In some implementations, non-player characters may serve as quest-givers throughout the episode. Quests use the conversation system shown above to direct player action. A NPC (e.g. 1600) can present at least 3 basic events: a minor page collection quest, a Journal Event, and a Paper Play™ mini-game. Each quest can include, but is not limited to, four states: Presentation and acceptance of the quest; Required questing behavior; Quest completion (turning in the results of the quest to the NPC quest-giver); and Award of points and/or other items (e.g., keys).

Successful quest completion results in point rewards and, in some cases, special achievements. In all cases, the player will see a Quest Completion message like the one below. This is an example of an event that a player might want to post to the social networks.

In some implementations of the technology, a non-player character can assigns a page collection quest. When a page collection quest is completed and turned in, a specific portion of the Journal becomes accessible. In this way, the journal is progressively revealed as the player interacts with the 3D world. Page collection quests are assigned by quest-givers. Pages are counted in the HUD. One or more page collection achievements may be awarded. A success message may appears when the final page of the current quest is collected.

In some implementations of the technology, when the player turns in pages, a specific section(s) of the Journal becomes available. A Journal Event follows each page collection quest. This event affords the opportunity to issue interim checks for comprehension regarding the new material. NPCs may remind players about accessing the journal via the backpack. A failed comprehension check may automatically launch the journal.

In some implementations of the technology, some areas are locked and require a key for access. Feedback is provided to indicate a locked door (e.g., knob turns, a creak, click, and dull thud are heard). Additionally, a game message may be displayed that further elucidates the situation.

In some implementations of the technology, props are dynamic objects that react when touched. A prop may be very simple like a sheet or paper or more complicated like an inclined plane. There are at least two types of props: touchable and destructible objects. These items may be further classified according to the information they reveal. Some objects unfold non-educational materials (e.g., a hint about the location of a secret treasure chest) while other contain educational data (e.g., a synopsis of experimental methods in the 1600s). Players receive points for discovery of these interactive props according to their educational value. Destructible objects smash when touched, as if they had been struck with force. Inside may be hidden other objects of value. Crates and furniture are examples of destructible props. Touchable objects display a simple multi-media message. Usually, these messages relate to the episode's learning objectives, scientific inquiry, or general scientific knowledge.

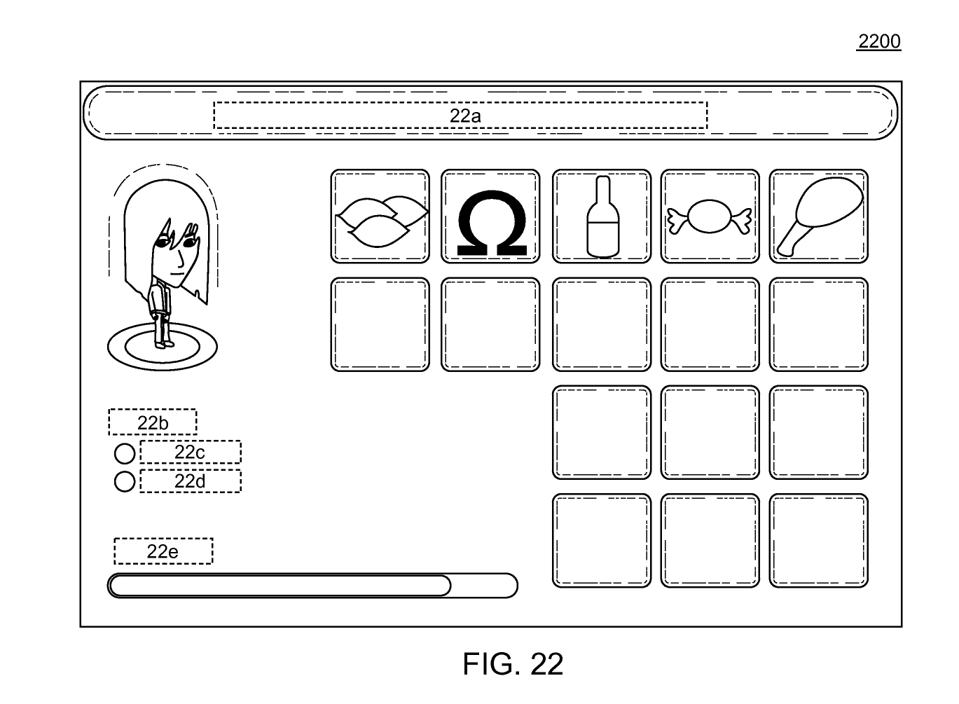

Some implementations of the technology contain an Inventory System 2200, such as a persistent backpack that houses the player's inventory as well as a number of vital educational resources, see for example, FIG. 22. Referring to FIG. 22, the following identification numbers correspond to the following text as follows: 22a: YOUR BACKPACK; 22b: quest; 22c: collect 5 pages; 22d: return to Christina and 22e: mastery.

As described above, some implementations of the technology include a Glossary. The glossary is a resource that is dynamically populated based upon location in the game.

As described above, some implementations of the technology involve quest items. Quest items are objects required to complete specific quests. They may be discovered by the player or rewarded by a NPC. Quest items remain in the inventory until the quest is turned in; at this point, the items may be purged from the inventory or may persist in the inventory. Pages and Fibonacci flowers examples of quest items.

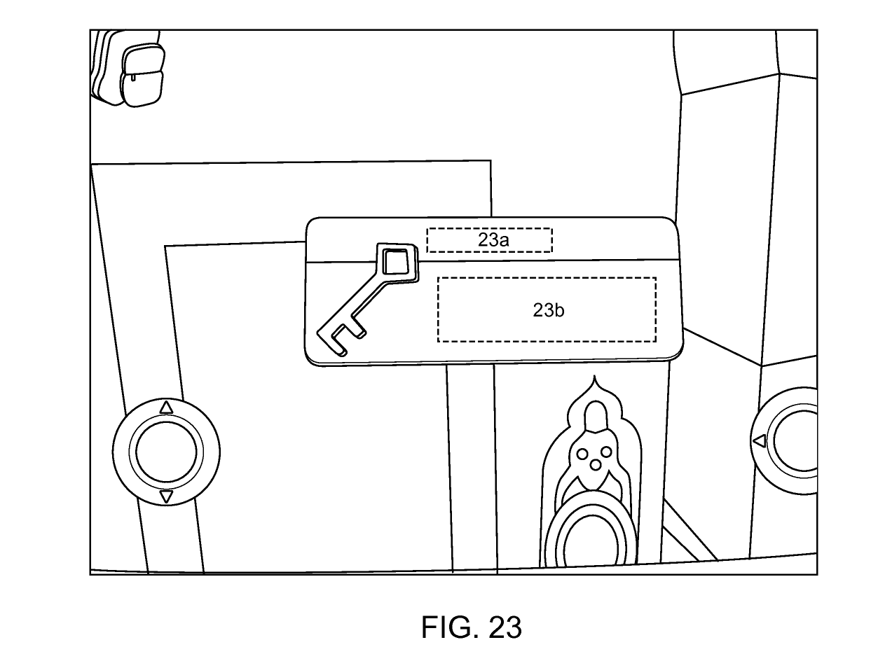

Implementations of the technology can involve keys. Keys allow access to otherwise locked areas. When a player begins the game, much of the 3D world is locked. If a player taps a locked door without the proper key in inventory, a message appears. Some keys are hidden in the environment while others are rewarded by the NPCs. FIG. 23 shows an example of a screenshot that is displayed when a user-player attempts to open a locked item. Referring to FIG. 23, the following identification numbers correspond to the following text as follows: 23a: LOCKED!; and 23b: This door is locked, you need the silver key to enter. Keys may also be acquired upon mastery of certain subject matter.

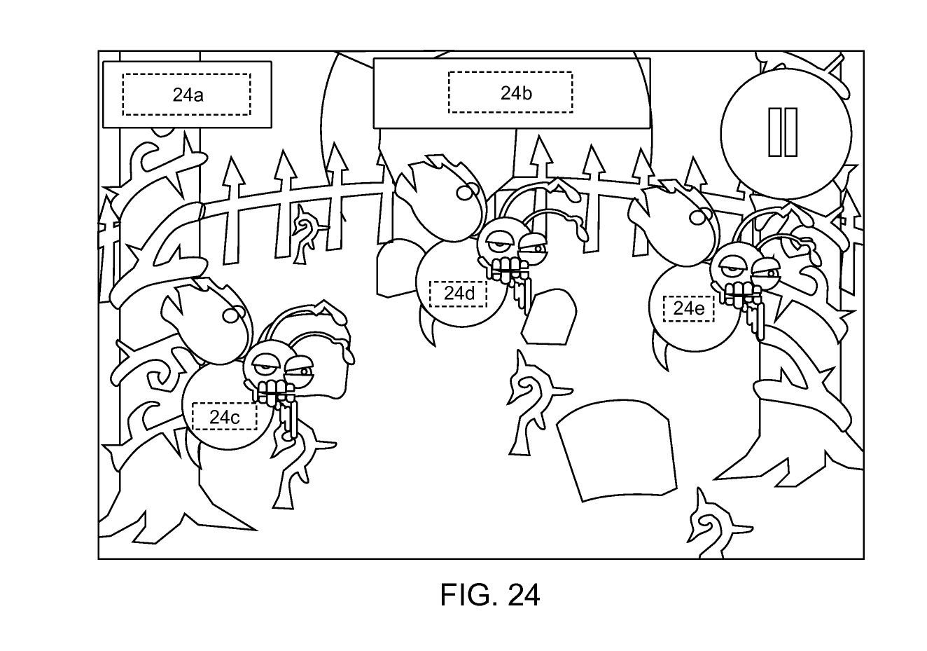

Another implementation of the technology is a Zombee type game for teaching orders of magnitude, significant digits and scientific notation, see for example FIG. 24, which shows a screenshot from a Zombee type game. Between each round of a Zombee game (and at the end of the game), the player may be presented with a MIM or nugget to supplement instructional content. Referring to FIG. 24, the following identification numbers correspond to the following text as follows: 24a: kilo; and 24b: Score; 24c: yotta; 24d: c; and 24e: 1E3.

Within each Round of a Zombee game, the player is given a value related to the topic covered by the learning objective. The given value appears in a field in the lower left hand corner of the screen. For example, if the player is in Aisle 1, the given value will be chosen from one of the three following categories: “Orders of Magnitude,” “Prefixes,” or “Symbols.” Zombeez with values then fly up into the air within the player's view (perhaps hover for 3 to 7 seconds), then fall off the screen, outside the player's view. These values are assigned via a random number generator such that one value must be an equivalent from another category; other two values may be any value from any category. None of the values may have the same value as the given value. Player must then swipe the zombee with the equivalent value. Swiping the zombee with the equivalent value adds points to the score. Swiping the zombee with an incorrect value subtracts points from the score. The player's score is present and updated in a field in the upper left hand corner of the screen. Taking no action and swiping no zombees earns the player a strike; if the player accumulates three strikes, the game automatically ends. No graphic will appear upon the device screen to indicate the player or weapon other than saw blade trail; these will eventually disappear over time.

The Zombee game screens may also display nuggets of instructional content at bottom of screen. Before entering a Round the player may be presented with a mini-instructional module (MIM) in order to introduce the instructional content to the player. After leaving an aisle, the player should be presented with another MIM in order to summarize the material. If the player ends the game in failure, the MIM may address the issue that ended the game and point out a fact relevant to the lesson involved. If the player ends the game in success, the MIM may summarize a teaching point and point out an interesting fact relevant to the lesson.

As stated above, FIG. 24 shows an example of a possible Zombee game screenshot. In FIG. 24, only three Zombeez appear on screen at once and simultaneously; Zombeez will be launched and fall vertically. Only one Zombee has the equivalent solution value, the other two Zombeez have bogus values. If the solution Zombee is sliced, score increases by 25 points. If a bogus Zombee is sliced, score decreases by 10 points. If no Zombeez are sliced, a strike is given; upon three strikes, Zombees swarm the player (game over). Alternatively, if 10 bogus Zombeez have been sliced, Zombeez swarm the player (game over).

The electronic device displays the game over screen when the player loses the game. The game over screen will display the correct answer, the player's score, and the high score. The game over screen also displays a nugget of instructional content and/or leads to a MIM. The MIM could be corrective, if the player failed to complete the game by successfully slicing 10 Zombeez or summative if the player ends the game in success, depending up the context of the resolution of the game.

In some implementations of the technology, incorporating various levels of increasing or adaptive difficulty will change the scope of development for this game. As described above, there is only one level of difficulty defined in the basic scope of a Zombee game. However, others are possible within this disclosure.

Some implementations of the technology may incorporate a weapon system. Incorporating a weapon system into a Zombee game can advantageously increase the depth of game play and the level of player enjoyment, however a weapon system will also change the scope of development for this game.

A HUD may be provided to show the given value, score, strikes, and a pause button; option: high score; option: display instructional content in field at bottom of screen.

Within some implementations of the technology, achievements are rewards presented during game play for various accomplishments and have become integral to the modern gamer's user experience. The high score is no longer the only bragging right available to gamers. Gamers may now also achieve different experiences with a game as characterized by an achievement system.

In addition to a brief narrative, the opening sequence will define and discuss scientific notation and significant digits in order to activate existing knowledge and introduce orders of magnitude with respect to powers of ten and SI Unit Prefixes.

In some implementations, between games, the player is presented with a short instructional module detailing some aspect of significant digits and scientific notation. Feedback may also be provided summarizing the player's performance and providing some additional factual information regarding significant digits and scientific notation.

Aspects of the technology may implement two types of Mini-Instructional Modules (MIMs) in order to represent the instructional content for the first portion of a Zombee game. Each MIM should be preceded by an introductory paragraph in order to give the player a frame of reference for what they are about to see.

A first MIM may be a table oriented in landscape with row titles of Prefix, Prefix Symbol (Symbol), Power of Ten (10ⁿ), and Decimal Value (Decimal). The column titles will then collect all the related information across those rows. The table can be represented as a single graphic that can be scrolled left/right upon the iPod Touch/iPhone.

The second MIM can be two discs or dials that move synchronically in response to an upward/downward swipe on the iPod Touch/iPhone. This MIM will be a juxtaposition of the SI prefix data applied to distance/length and a picture of some real world object or distance. The right disc will present an SI prefix name, an SI prefix symbol, a power of ten, and a decimal value. The left disc will present a graphic of some object representing the order of magnitude represented on the right disc.

Implementations of the technology may present the case for using significant digits and the rules used to determine the number of significant digits in a given measurement. The technology can present a short quiz in which the player is given a number and asked to determine the correct number of significant digits. The answer choices will be labels affixed to buttons. A correct answer displays a congratulatory remark. An incorrect answer displays an encouraging remark and displays the rule that applies.

One MIM seeks to resolve the ambiguous case of significant digits. The technology can show that by separating the number of significant digits from the order of magnitude, precision can be increased.

Within the technology a UMS can comprise a Basic Main Menu, a Pause Menu, and a Game Over Menu & Buttons as defined by the Universal Twisted Menu Design Document with necessary customizations, integrated with mild horror archetypes or overtones.

Within the technology a HUD may comprise, but is not limited to, the following elements: a given value and field, score, strikes (active, inactive), pause button; a high score and field; and the option to display instructional content.

A Zombee game may exist in one level implemented using a Model-View-Controller (MVC) software architecture or other software or firmware architecture. This will allow game logic, game data, and game user interface to be developed, tested, and maintained independently of one another. The controller may maintain the game logic and state, storing and managing data sand updating the player's view of the game, whether it be a menu, game instance, or MIM. This can allow data to be store in two discrete structures, PlayerData and GameData, which can then be serialized in an XML file stored locally to the device and sent to a remote server for use with other applications external or internal to the device.

Those skilled in the art will recognize that other game type paradigms may be implemented within this disclosure without departing from the technology.

The present disclosure may be embodied or implemented in other specific forms without departing from its essential characteristics. The described implementations are to be considered in all respects as illustrative, and not restrictive. The scope of the disclosure is, therefore, indicated by the appended claims, rather than by the foregoing description. All changes that come within the meaning and range of equivalency of the claims are to be embraced within their scope.

1. A method for providing a visual lesson on a device, comprising:
receiving a first input signal indicating a request for a lesson;
receiving data for at least one visual lesson which is at least one lesson in a series of connected lessons, wherein the series of connected lessons are sequential lessons;
executing the data for the at least one visual lesson on a processor of the device;
displaying a graphical interface that includes a portion of the at least one visual lesson;
providing one or more response options;
receiving a second input signal indicative of a selection of one of the response options;
determining if the selection of the response options matches an answer to the visual lesson;
displaying an indication of the correctness of the selection of the response option; and
creating an access code upon completion of at least one lesson for enabling the receipt of at least one visual lesson when the selection matches an answer to the visual lesson.

2. (canceled)

3. The method as recited in claim 1, wherein said receiving data for at least one visual lesson is via a connection to the Internet.

4. The method as recited in claim 3, wherein said at least one visual lesson is made available for purchase via a website.

5. The method as recited in claim 1, wherein said receiving data for at least one visual lesson is via a removable memory module.

6. The method as recited in claim 1, further comprising receiving a third input signal indicating a request for a subsequent lesson and receiving data for at least one additional visual lesson when the access code matches a predetermined code for the at least one additional visual lesson.

7. The method as recited in claim 6, wherein the at least one visual lesson and the at least one additional visual lesson are connected via a common story.

8. The method as recited in claim 7, wherein the story is one of a chronological series of events, a course outline, and a theme.

9. The method as recited in claim 6, wherein the at least one visual lesson is a single lesson and the at least one additional visual lesson is a single additional visual lesson.

10. The method as recited in claim 1 wherein displaying an indication of the correctness of the selection of the response option is transmitted via at least one social media.

11. An electronic device comprising:
a display;
one or more network interfaces;
an input interface;
a processor module communicatively coupled to the display, input interface, and one or more network interfaces, wherein the processor is capable of:
receiving a first input signal indicating a request for a lesson from the input interface;
receiving data for at least one visual lesson which is at least one lesson in a series of connected lessons, wherein the series of connected lessons are sequential lessons, wherein said data is received via the one or more network interfaces;
executing the data for the at least one visual lesson on a processor of the device;
displaying a graphical interface on the display that includes a portion of the at least one visual lesson;
providing one or more response options on the graphical interface;
receiving a second input signal indicative of a selection of one of the response options from the input interface;
determining if the selection of the response options matches an answer to the visual lesson;
displaying an indication of the correctness of the selection of the response option on the graphical interface;
creating an access code upon completion of at least one lesson for enabling the receipt of at least one visual lesson when the selection matches an answer to the visual lesson.

12. The electronic device as recited in claim 11, wherein said receiving data for at least one visual lesson is via a connection to the Internet.

13. The electronic device as recited in claim 12, wherein said at least one visual lesson is made available for purchase via a website.

14. The electronic device as recited in claim 11, wherein said receiving data for at least one visual lesson is via a removable memory module.

15. The electronic device as recited in claim 11, further comprising receiving a third input signal indicating a request for a subsequent lesson and receiving data for at least one additional visual lesson when the access code matches the code for the at least one additional visual lesson.

16. The electronic device as recited in claim 15, wherein the at least one visual lesson and the at least one additional visual lesson are connected via a common story.

17. The electronic device as recited in claim 16, wherein the story is one of a chronological series of events, a course outline, and a theme.

18. The electronic device as recited in claim 17, wherein the at least one visual lesson is a single lesson and the at least one additional visual lesson is a single additional visual lesson.

19. A computer readable medium storing computer executable code for implementing a method comprising:
at least one operating module:
stored on the medium, and
operable upon execution by a processor to:
receive an input signal indicating a request for a lesson;
receive data for at least one visual lesson which is at least one lesson in a series of connected lessons, wherein the series of connected lessons are sequential lessons;
execute the data for the at least one visual lesson on a processor of the device;
display a graphical interface that includes a portion of the at least one visual lesson;
provide one or more response options;
receive a signal indicative of a selection of one of the response options;
determine if the selection of the response options matches an answer to the visual lesson;
display an indication of the correctness of the selection of the response option;
create an access code upon completion of at least one lesson for enabling the receipt of at least one visual lesson when the selection matches an answer to the visual lesson.

20. The computer readable medium as recited in claim 19, wherein said receipt of data for at least one visual lesson is via a connection to the Internet.

21. The computer readable medium as recited in claim 19, wherein said display of an indication of the correctness of the selection of the response option is transmitted via at least one social media.

22. The computer readable medium as recited in claim 20, wherein said at least one visual lesson is made available for purchase via a website.

23. The computer readable medium as recited in claim 19, wherein said receipt of data for at least one visual lesson is via a removable memory module.

24. The computer readable medium as recited in claim 19, wherein the at least one operating module is further operable upon execution by a processor to: receive a subsequent lesson request signal and receive data for at least one additional visual lesson when the access code matches the code for the at least one additional visual lesson.

25. The computer readable medium as recited in claim 22, wherein the at least one visual lesson and the at least one additional visual lesson are connected via a common story.

26. The computer readable medium as recited in claim 24, wherein the story is one of a chronological series of events, a course outline, and a theme.

27. The computer readable medium as recited in claim 24, wherein the at least one visual lesson is a single lesson and the at least one additional visual lesson is a single additional visual lesson.

28. The method of claim 7 wherein the story is represented by at least one three-dimensional image and wherein the at least one visual lesson is represented by at least one two-dimensional image.
